(19) United States
(12) Patent Application Publication
(10) Pub. No.: US 2025/0120448 A1
(43) Pub. Date: Apr. 17, 2025

(54) ATOMIZATION DEVICE AND CONTROL METHOD THEREOF, AND STORAGE MEDIUM

(71) Applicant: Shenzhen Ske Technology Co., Ltd., Shenzhen City (CN)

(72) Inventors: Lijun YU, Shenzhen (CN); Guozhu LIANG, Shenzhen (CN); Shiming WANG, Shenzhen (CN)

(21) Appl. No.: 18/397,803

(22) Filed: Dec. 27, 2023

(30) Foreign Application Priority Data
Oct. 16, 2023 (CN) 202311337317.X

(51) Int. Cl. A24F 40/53; A24F 40/10; A24F 40/57; A24F 40/60; H02J 7/00; H05B 1/02

(52) U.S. Cl. CPC A24F 40/53; A24F 40/10; A24F 40/57; A24F 40/60; H05B 1/0244; H02J 7/0042

(57) ABSTRACT

Disclosed are an atomization device and a control method thereof, and a storage medium. The method includes: acquiring a first remaining electric quantity NI of the first power supply and a second remaining electric quantity N2 of the second power supply, a power of the body electronic element being a body power P1, a power of the additional electronic element being an additional power P2, and a power of the display screen being a display power P3; calculating a remaining service duration according to the first remaining electric quantity N1, the second remaining electric quantity N2, the body power P1, the additional power P2, and the display power P3; controlling the display screen to display the remaining service duration. The chnical solution of the present disclosure is conducive to better use of the atomization device by users.

### CROSS-REFERENCE TO RELATED APPLICATION

This application claims priority to Chinese Patent Application No. 202311337317.X, filed with the China National Intellectual Property Administration and entitled “Atomization Device and Control Method Thereof, and Storage Medium” on Oct. 16, 2023, which is incorporated herein by reference in its entirety.

### TECHNICAL FIELD

The present disclosure relates to the field of atomization device technology, and particularly to an atomization device and a control method thereof, and a storage medium.

### BACKGROUND

With the development of economy and the improvement of people's living standard, higher requirements are put forward for atomization devices. In order to satisfy the requirements people for intelligent interaction with the atomization device, a number of electronic elements are added to the atomization device. As the number of the electronic elements in the atomization device increases, there are many factors that make the consumption of battery power difficult to estimate. Accordingly, when people uses the atomization device, the remaining service duration of the atomization device cannot be accurately estimated, which is not conducive to rational use of the atomization device.

### SUMMARY

The main purpose of the present disclosure is to provide a method for controlling an atomization device, which is intended to provide the user with visualized remaining service duration, which is conducive to the rational use of the atomization device by the user and improving the use experience of the user.

In view of this, the present disclosure provides a method for controlling an atomization device, the atomization device including a power supply box, a cartomizer storing a liquid to be atomized, a body electronic element, an additional electronic element, and a display screen; the body electronic element being configured to enable the atomization device to transform the liquid to be atomized into an atomizing gas, the additional electronic element being configured to enable the atomization device to implement an additional function, the body electronic element being provided inside the cartomizer, the additional electronic element and the display screen being mounted on the power supply box or on the cartomizer; the power supply box being detachably connected to the cartomizer, a first power supply being provided in the power supply box, a second power supply being provided in the cartomizer, both the first power supply and the second power supply being electrically connected to the body electronic element, the first power supply being electrically connected to the second power supply, the display screen being electrically connected to the first power supply and/or the second power supply, and the additional electronic element being electrically connected to the first power supply and/or the second power supply;

the method may include:

acquiring a first remaining electric quantity N1 of the first power supply and a second remaining electric quantity N2 of the second power supply, wherein the body electronic element has a body power P1, the additional electronic element has an additional power P2, and the display screen has a display power P3; calculating a remaining service duration according to the first remaining electric quantity N1, the second remaining electric quantity N2, the body power P1, the additional power P2, and the display power P3; and controlling the display screen to display the remaining service duration.

Optionally, the method may further includes: after acquiring the first remaining electric quantity N1 of the first power supply and the second remaining electric quantity N2 of the second power supply, wherein the power of the body electronic element is the body power P1, the power of the additional electronic element is the additional power P2, and the power of the display screen is the display power P3, calculating a total remaining electric quantity according to the first remaining electric quantity N1 and the second remaining electric quantity N2; comparing the total remaining electric quantity to a first preset electric quantity N3; when determining that the total remaining electric quantity is greater than the first preset electric quantity N3, calculating the remaining service duration according to the first remaining electric quantity N1, the second remaining electric quantity N2, the body power P1, the additional power P2, and the display power P3.

Optionally, the second power supply supplies an electric energy to the body electronic element, and the first power supply supplies electric energies to the display screen and the additional electronic element; the calculating the remaining service duration according to the first remaining electric quantity N1, the second remaining electric quantity N2, the body power P1, the additional power P2, and the display power P3 further includes: calculating and denoting a value of N1/(P2+P3) as a first service duration T1, calculating a second service duration T2 during which the body electronic element is operable according to the second remaining electric quantity N2 and the body power P1; comparing the first service duration T1 to the second service duration T2; when determining that the second service duration T2 is greater than or equal to the first service duration T1, determining the second service duration T2 as the remaining service duration; and when determining that the second service duration T2 is less than the first service duration T1, calculating and denoting a value of [N1−(P2+P3)*T2]/(P1+P2+P3) as T3, and determining a sum of T2 and T3 as the remaining service duration.

Optionally, the method may further include: after comparing the total remaining electric quantity to the first preset electric quantity N3, turning off the additional electronic element when determining that the total remaining electric quantity is less than or equal to the first preset electric quantity N3; and calculating the remaining service duration according to the first remaining electric quantity N1, the second remaining electric quantity N2, the body power P1, and the display power P3.

Optionally, the second power supply supplies an electric energy to the body electronic element, and the first power supply supplies an electric energy to the display screen; the calculating the remaining service duration according to the first remaining electric quantity N1, the second remaining electric quantity N2, the body power P1, and the display power P3 further includes: calculating and denoting a value of N1/P3 as a first service duration T1, calculating a second service duration T2 during which the body electronic element is operable according to the second remaining electric quantity N2 and the body power P1; comparing the first service duration T1 to the second service duration T2; when determining that the second service duration T2 is greater than or equal to the first service duration T1, determining the second service duration T2 as the remaining service duration; and when determining that the second service duration T2 is less than the first service duration T1, calculating and denoting a value of (N1−P3*T2)/(P1+P3) as T3, and determining a sum of T2 and T3 as the remaining service duration.

Optionally, the method may further include: after comparing the total remaining electric quantity to the first preset electric quantity N3, comparing the total remaining electric quantity to a second preset electric quantity N4, wherein the second preset electric quantity is less than the first preset electric quantity; and when determining that the total remaining electric quantity is less than or equal to the second preset electric quantity N4, turning off the display screen, and calculating the remaining service duration according to the first remaining electric quantity N1, the second remaining electric quantity N2, and the body power P1.

Optionally, the calculating the remaining service duration according to the first remaining electric quantity N1, the second remaining electric quantity N2, and the body power P1 further includes: acquiring a transfer ratio η of an electric quantity charging the second power supply by the first power supply; calculating and denoting a value of N1*η as a transferred electric quantity N5; calculating and determing a value of (N5+N2)/P1 as the remaining service duration.

Optionally, the calculating the second service duration T2 during which the body electronic element is operable according to the second remaining electric quantity N2 and the body power P1 further includes: acquiring an average smoking duration and an average power consumption of the atomization deivice for a previous preset number of times; calculating an average power consumption rate according to the average power consumption and the average smoking duration; comparing the average power consumption rate to a preset power consumption rate; when determining that the average power consumption rate is greater than the preset power consumption rate, the second service duration T2 can be determined by T2=αN2/P1, α ranges from 0.5 to 0.85; when determining that the average power consumption rate is less than or equal to the preset power consumption rate, the second service duration T2 can be determined by T2=βN2/P1, β is greater than 0.85 and less than 1.

The present disclosure further provides an atomization device, including a power supply box and a cartomizer, and further including a processor and a memory storing a control program, wherein the processor, when executing the comotrol program, implements the steps of the method for controlling the atomization device including: acquiring a first remaining electric quantity N1 of the first power supply and a second remaining electric quantity N2 of the second power supply, the body electronic element having a body power P1, the additional electronic element having an additional power P2, and the display screen having a display power P3; calculating a remaining service duration according to the first remaining electric quantity N1, the second remaining electric quantity N2, the body power P1, the additional power P2, and the display power P3; and controlling the display screen to display the remaining service duration.

The present disclosure further provides a computer-readable storage medium, on which a control program is stored, the control program, when executed by a processor, causes the processor to implement the steps of the method for controlling the atomization device including: acquiring a first remaining electric quantity N1 of the first power supply and a second remaining electric quantity N2 of the second power supply, the body electronic element having a body power P1, the additional electronic element having an additional power P2, and the display screen having a display power P3; calculating a remaining service duration according to the first remaining electric quantity N1, the second remaining electric quantity N2, the body power P1, the additional power P2, and the display power P3; and controlling the display screen to display the remaining service duration.

In the technical solution of the present disclosure, a first remaining electric quantity N1 of the first power supply and a second remaining electric quantity N2 of the second power supply are acquired, in which a power of the body electronic element is a body power P1, a power of the additional electronic element is an additional power P2, and a power of the display screen is a display power P3; a remaining service duration is calculated according to the first remaining electric quantity N1, the second remaining electric quantity N2, the body power P1, the additional power P2, and the display power P3; and the display screen is controlled to display the remaining service duration. In such a manner, first of all, the user can be accurately informed of the remaining service duration of the current atomization device which can continue to operate, so that the user can reasonably plan the use of the atomization device, for example, how to reasonably schedule the smoking time. For example, the power supply box is detached and charged at the appropriate time, which is beneficial for the user to better use the atomization device. Secondly, in the technical solution of the present disclosure, the second power supply is utilized to power the body electronic element (including the evaporation device), since the second power supply and the body electronic element are both mounted on the cartomizer, the relative position and connection relationship between the second power supply and the body electronic element are more reliable, so that the second power supply can supply the electric energy to the body electronic element more stably and reliably. In addition, by providing the first power supply and the second power supply simultaneously, the battery life of the atomization device is greatly improved. In addition, the power supply box and the cartomizer are arranged to be detached, and both of which are provided with the first power supply and the second power supply respectively, so that the cartomizer having the second power supply can continue to operate when the power supply box having the first power supply is charging, accordingly the cartomizer can continue to operate when the power supply box is charging, which is conducive to the continuous use of the atomization device by the user.

### BRIEF DESCRIPTION OF THE DRAWINGS

In order to describe the technical solution in the embodiments of the present disclosure or the conventional technology more clearly, accompanying drawings required for the description of the embodiments or the conventional technology will be briefly introduced. Obviously, the accompanying drawings in the following description are merely some of the embodiments of the present disclosure, and those skilled in the art can obtain other drawings according to these drawings without any inventive effort.

FIG. 1 is a schematic structure diagram of an atomization device according to an embodiment of the present disclosure.

FIG. 2 is an exploded view of the structure in the embodiment shown in FIG. 1.

FIG. 3 is an exploded view of an structure of a cartomizer in FIG. 2 according to an embodiment of the present disclosure.

FIG. 4 is an exploded view of a structure of a power supply box in FIG. 2 according to an embodiment of the present disclosure.

FIG. 5 is a schematic diagram of the structure in FIG. 4 from another view.

FIG. 6 is a flow chart showing a method for controlling an atomization device according to an embodiment of the present disclosure.

FIG. 7 is a flow chart showing a method for controlling an atomization device according to another embodiment of the present disclosure.

FIG. 8 is a flow chart showing a method for controlling an atomization device according to another embodiment of the present disclosure.

FIG. 9 is a flow chart showing a method for controlling an atomization device according to another embodiment of the present disclosure.

### REFERENCE SIGNS

100, cartomizer; 110, drip tip;
200, power supply box; 210, charging connector;
220, discharging structure; 120, housing;
130, charging device; 150, second power supply; 260, first power supply;
160, liquid storage device; 170, evaporation device;
230, box body; 270, display screen;
290, additional electronic element.

### DETAILED DESCRIPTION OF THE EMBODIMENTS

The technical solution in the embodiments of the present disclosure will be described clearly and completely with reference to the accompanying drawings of the embodiments. Obviously, the described embodiments are merely some embodiments in the present disclosure, and are not all embodiments. Those skilled in the art can obtain other embodiments based on the embodiments in the present disclosure without any inventive effort, and these embodiments all fall within the scope of the present disclosure.

It should be noted that all directional indications (such as up, down, left, right, front, back, etc.) in the embodiments of the present in the present disclosure are merely intended to explain the relative positional relationship between components and motion situations of the components in specific conditions (as shown in the drawings), when the specific conditions change, the directional indications may change accordingly.

In addition, the expression in the present disclosure referring to “first”, “second”, etc., are merely used for descriptive purposes and are not to be understood as indicating or implying the relative importance or as implicitly indicating the quantity of the technical features indicated. Thus, a feature defined as “first” or “second” may explicitly or implicitly include at least one of the features. In addition, “and/or” in the present disclosure may include three solutions, for example, A and/or B may include a technical solution satisfying A, a technical solution satisfying B, and a technical scheme satisfying both A and B. In addition, the technical solutions in various embodiments can be combined with each other, but must be based on the realization of ordinary technical personnel in the art. When there are contradictions in the combinations of technical solutions or these combinations cannot be implemented, it shall be considered that such combinations of technical solution do not exist and are not within the scope of the protection of the present disclosure.

The present disclosure in the embodiments provides an atomization device, a method for controlling the atomization device, and a storage medium. The method for controlling the atomization device is applied to the atomization device (the atomization device has two independent power supplies, and both the power supplies can supply power to an evaporation device 170 of the atomization device), to display the available remaining service duration of the atomization device under different working conditions, so that a user can be intuitively aware of the current situation of the atomization device, which is helpful for the user to use the atomization device more reasonably. The atomization device generally refers to an electronic product, and the evaporation device 170 of the electronic product evaporates the e-liquid under the action of electrical energy provided by the power supply for the user to smoke through the drip tip 110.

The specific structure of the atomization device and the method for controlling the atomization device will be described below.

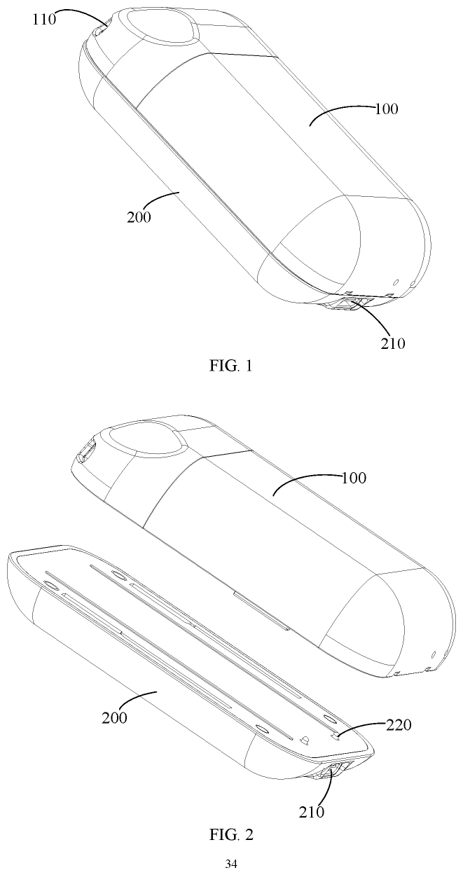

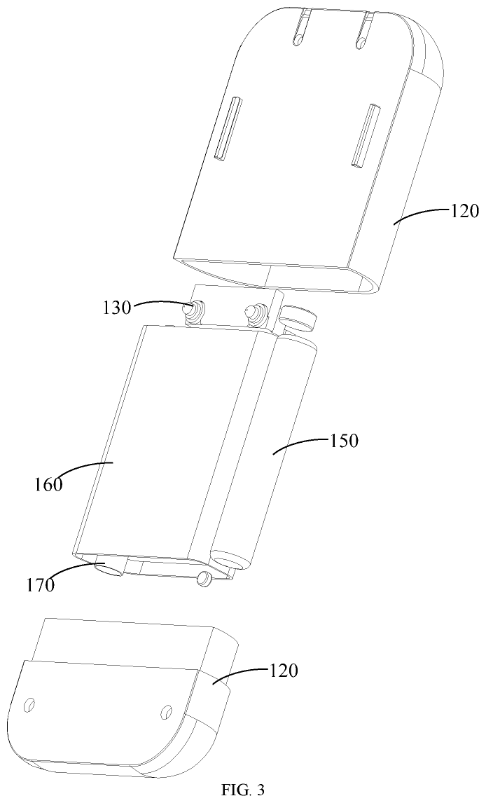

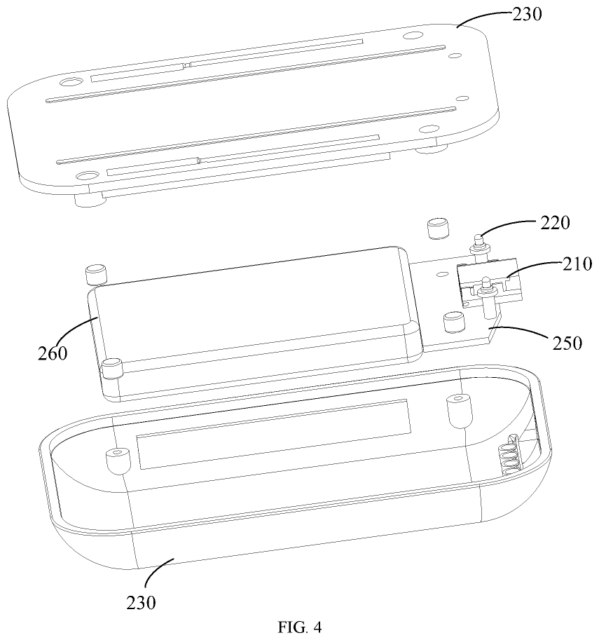

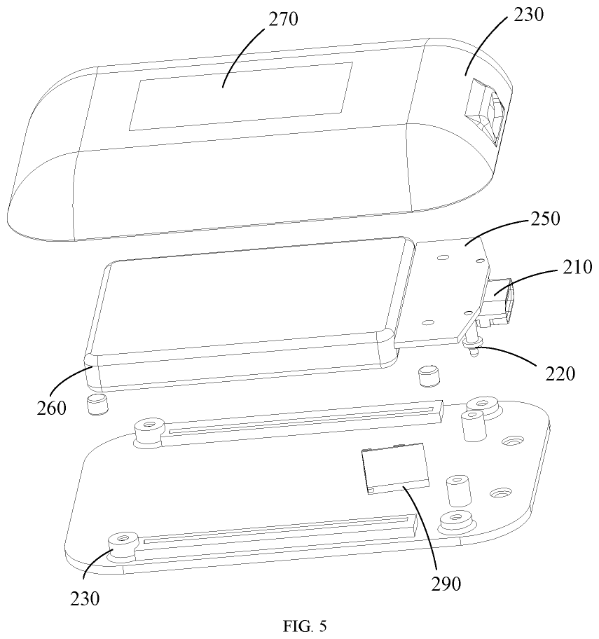

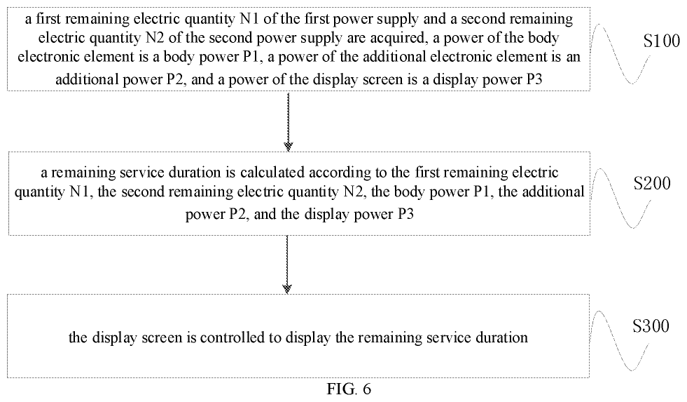

Referring to FIGS. 1 to 6, in an embodiment of the present disclosure, an atomization device may include a power supply box 200, a cartomizer 100 storing a liquid to be atomized, a body electronic element, an additional electronic element 290, and a display screen 270. The body electronic element is configured to enable the atomization device to transform the liquid to be atomized into an atomizing gas, that is, the body electronic element is an essential electronic element of the atomization device to implement the atomization function. The additional electronic element 290 is configured to enable the atomization device to implement an additional function. The additional electronic element 290 may be different according to different additional functions required to be implemented. If it is desired to implement a communication function between the atomization device and the outside world, the additional electronic element 290 may include a WIFI module, a Bluetooth module, or the like. The body electronic element is provided inside the cartomizer 100, the additional electronic element 290 and the display screen 270 are mounted on the power supply box 200 or on the cartomizer 100. For example, the additional electronic element 290 and the display screen 270 are both mounted on the power supply box 200. The power supply box 200 is detachably connected to the cartomizer 100. A first power supply 260 is provided in the power supply box 200, and a second power supply 150 is provided in the cartomizer 100. Both the first power supply 260 and the second power supply 150 are electrically connected to the body electronic element, and the first power supply 260 is electrically connected to the second power supply 150. The display screen 270 is electrically connected to the first power supply 260 and/or the second power supply 150, and the additional electronic element 290 is electrically connected to the first power supply 260 and/or the second power supply 150.

A method for controlling the atomization device may include following steps.

S100: a first remaining electric quantity N1 of the first power supply 260 is acquired, a second remaining electric quantity N2 of the second power supply 150 is acquired, a power of the body electronic element is a body power P1, a power of the additional electronic element 290 is an additional power P2, and a power of the display screen 270 is a display power P3.

S200: a remaining service duration is calculated according to the first remaining electric quantity N1, the second remaining electric quantity N2, the body power P1, the additional power P2, and the display power P3.

S300: the display screen 270 is controlled to display the remaining service duration.

Specifically, in the present embodiment, the power supply box 200 may include a box body 230 in which a first power supply 260, a charging and discharging board 250, a charging connector 210, and a discharging structure 220 are provided. The charging and discharging board 250 is electrically connected to the first power supply 260, the charging connector 210, and the discharging structure 220. The first power supply 260 may be electrically connected to an external power supply through the charging connector 210 and the charging and discharging board 250, in order to implement the charging of the first power supply 260. The first power supply 260 may be electrically connected to the second power supply 150 and the evaporation device 170 through the charging and discharging board 250 and the discharging structure 220, so that the first power supply 260 may supply power to the second power supply 150 and the evaporation device 170. Positions where the additional electronic element 290 and the display screen 270 are mounted and connection modes thereof may be various, for example, when the additional electronic element 290 and the display screen 270 are electrically connected to the first power supply 260, the first power supply 260 may supply power to the additional electronic element 290 and the display screen 270. In some embodiments, the additional electronic element 290 and the display screen 270 may be mounted on the cartomizer 100, and the additional electronic element 290 and the display screen 270 are electrically connected to the second power supply 150. In the embodiment, the additional electronic element 290 and the display screen 270 are mounted on the power supply box 200 and electrically connected to the first power supply 260.

The cartomizer 100 may include a housing 120, a second power supply 150, an evaporation device 170, and a liquid storage device 160 provided within the housing 120. The evaporation device 170 operates to atomize the e-liquid in the liquid storage device 160 for use by a user. The cartomizer 100 may further include a drip tip 110 for the user to smoke. The drip tip 110 is in communication with the liquid storage device 160, so that the evaporated e-liquid can be discharged from the atomization device through the drip tip 110. The body electronic element is provided inside the housing 120, and the second power source 150 may provide the electric energy to the body electronic element, and also the cartomizer 100 can operate independently of the power supply box 200. When the additional electronic element 290 is electrically connected to the display screen 270 and the second power supply 150, the second power supply 150 may supply the electric energy to the additional electronic element 290 and the display screen 270.

It should be appreciated that, in order to facilitate charging of the second power supply 150, the cartomizer 100 may further include a charging device 130 which is electrically connected to the second power supply 150 and exposed to the housing 120. The charging device 130 is configured to be electrically connected to the discharging structure 220 provided on the power supply box 200, so that electric energy in the first power supply 260 can be transferred to the second power supply 150 through the discharging structure 220 and the charging device 130. When the power supply box 200 is assembled with the cartomizer 100, the charging device 130 is electrically connected to the discharging structure 220; and when the power supply box 200 is detached from the cartomizer 100, the charging device 130 is disconnected from the discharging structure 220.

The power supply box 200 and the cartomizer 100 can be detached in many modes, for example, by a snap connection, a magnetic attachment connection, a fastener connection such as a screw connection, an adhesive connection, and the like. As an example, the power supply box 200 is detachably connected to the cartomizer 100 in the magnetic attachment connection mode. The charging device 130 and the discharging structure 220 may have many forms, such as a charging contact point and a discharging connecting rod (both of which may abut against each other), a charging connector and a discharging connector (both of which may plug into each other), and the like, which should match the detachable connection between the power supply box 200 and the cartomizer 100, and are not particularly limited herein.

As for the step S100 in which a first remaining electric quantity N1 of the first power supply 260 is acquired, a second remaining electric quantity N2 of the second power supply 150 is acquired, a power of the body electronic element is a body power P1, a power of the additional electronic element 290 is an additional power P2, and a power of the display screen 270 is a display power P3, there may exist many modes to obtain the first remaining electric quantity and the second remaining electric quantity, for example, the remaining electric quantity of the power supply may be calculated by detecting the voltages of the first power supply 260 and the second power supply 150; alternatively, a current sensing resistor is connected in series between a positive electrode and a negative electrode of a battery, and a coulombmeter is induced when a current flows through the resistor, so that the current flowing through the battery can be calculated by detecting the induction. Accordingly, the changes in the battery power can be tracked accurately. The body power, the additional power, and the display power may be obtained by the detection, or may be obtained by the calculating parameters of corresponding elements.

As for the step S200 that the remaining service duration is calculated according to the first remaining electric quantity N1, the second remaining electric quantity N2, the body power P1, the additional power P2, and the display power P3, the remaining service duration may be calculated in many modes, such as a ratio of the total remaining electric quantity (sum of a first remaining electric quantity and a second remaining electric quantity) to the total power (sum of the body power, the additional power, and the display power). Alternatively, the remaining service duration can be calculated according to the specific power supply conditions. For example, the second power supply 150 mainly supplies power to the body electronic element, and the remaining service duration in which the body electronic element can operate can be calculated according to the second remaining electric quantity and the body power. The first power supply 260 is configured to supply the electric energy to the display screen 270 and the additional electronic element 290, and may further be configured to charge the second power supply 150 when the second power supply 150 is low. At the moment, the available remaining service duration of the display screen 270 and the additional electronic element 290 can be calculated according to the first remaining electric quantity, the additional power P2, and the display power P3.

As for the step S300 that the display screen 270 is controlled to display the remaining service duration. The remaining service duration displayed may be a duration parameter or a plurality of duration parameters. Specifically, when the remaining service duration displayed is a parameter, the remaining service duration of the atomization device for the user to smoke is displayed, that is, the remaining service duration during which the body electronic element can operate normally. When the remaining service duration includes a plurality of parameters, the remaining service duration during which the body electronic element operates normally can be displayed, and standby time (i.e., the remaining service duration during which only the additional electronic element 290 and the display screen 270 operate, the body electronic element does not operate) can also be displayed.

According to the technical solution of the present disclosure, the first remaining electric quantity N1 of the first power supply 260 is acquired, and the second remaining electric quantity N2 of the second power supply 150 is acquired; the power of the body electronic element is the body power P1, the power of the additional electronic element 290 is the additional power P2, and the power of the display screen 270 is the display power P3; the remaining service duration is calculated according to the first remaining electric quantity N1, the second remaining electric quantity N2, the body power P1, the additional power P2, and the display power P3; the display screen 270 is then controlled to display the remaining service duration. In such a manner, the user can know accurately how long the current atomization device can continue to operate, so that the user can reasonably plan to use the atomization device. For example, how to reasonably schedule the smoking time without charging. As an example, the power supply box 200 is detached and charged at appropriate time, which is beneficial for the user to better use the atomization device. In the technical solution of the present disclosure, the second power supply 150 is utilized to supply the electric energy to the body electronic element (including the evaporation device 170). Since both the second power supply 150 and the body electronic element are mounted on the cartomizer 100, the relative positional relationship and the connection relationship between the second power supply 150 and the body electronic element are more reliable, so that the second power supply 150 can supply the electric energy to the body electronic element more stably and reliably. In addition, the first power supply 260 and the second power supply 150 are provided simultaneously, and the endurance capability of the atomization device is greatly improved. In addition, the power supply box 200 and the cartomizer 100 are arranged in the detachable connection mode, and both of which are respectively provided with the first power supply 260 and the second power supply 150, so that the cartomizer 100 having the second power supply 150 can continue to operate when the power supply box 200 having the first power supply 260 is charged, accordingly the cartomizer 100 can continue to be used when the power supply box 200 is charged, thereby facilitating continuous use of the atomization device by the user.

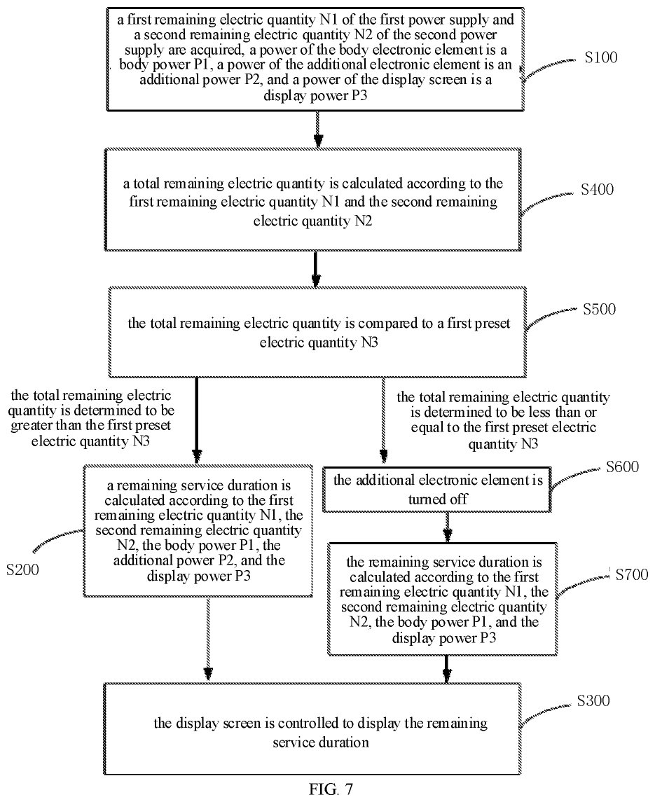

Referring to FIG. 7, with respect to how to calculate the remaining service duration, the operation states of the electronic element may be different in different operating conditions. After the step of acquiring the first remaining electric quantity N1 of the first power supply 260 and the second remaining electric quantity N2 of the second power supply 150, the power of the body electronic element being the body power P1, the power of the additional electronic element 290 being the additional power P2, and the power of the display screen 270 being the display power P3, the method may further include the following steps.

S400: a total remaining electric quantity is calculated according to the first remaining electric quantity N1 and the second remaining electric quantity N2.

S500: the total remaining electric quantity is compared to a first preset electric quantity N3.

When it is determined that the total remaining electric quantity is greater than the first preset electric quantity N3, the step S200 is performed, i.e., the remaining service duration is calculated according to the first remaining electric quantity N1, the second remaining electric quantity N2, the body power P1, the additional power P2, and the display power P3.

Specifically, in the embodiment, there may exist many modes to calculate the total remaining electric quantity according to the first remaining electric quantity and the second remaining electric quantity. For example, the total remaining electric quantity may be a sum of the first remaining electric quantity and the second remaining electric quantity. In other embodiments, when a transfer ratio of the first electric quantity into the second electric quantity is considered, the calculation of the total remaining electric quantity is performed by calculating a product of the first remaining electric quantity and the transfer ratio before calculating the sum of a value of the product and the second remaining electric quantity. The first preset electric quantity N3 is a threshold electric quantity, which may be factory-set, or may be set by a user according to a specific condition. When the total remaining electric quantity is greater than the first preset electric quantity, it indicates that the current total remaining electric quantity is large enough for all electronic elements to operate normally. At the moment, no electronic element is turned off, and the powers of all elements (including the body power P1, the additional power P2, and the display power P3) are taken into account when calculating the remaining electric quantity.

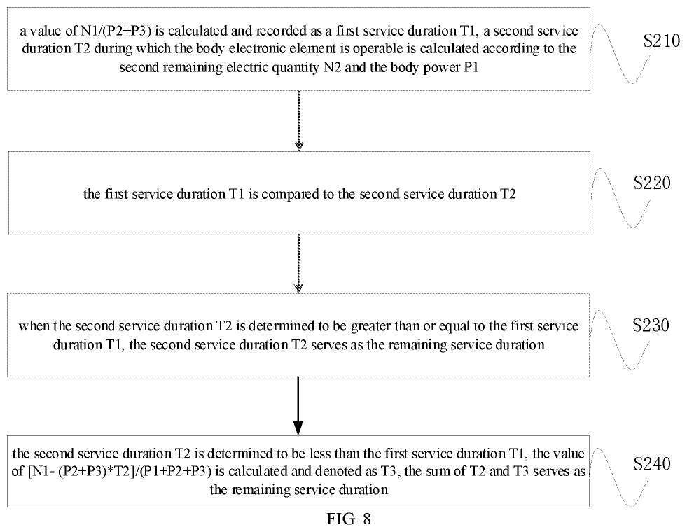

Referring to FIG. 8, a specific example of how to calculate the remaining service duration according to the first remaining electric quantity N1, the second remaining electric quantity N2, the body power P1, the additional power P2, and the display power P3 will be described below, which may include the following steps.

S210: a value of N1/(P2+P3) is calculated and recorded as a first service duration T1, a second service duration T2 during which the body electronic element is operable is calculated according to the second remaining electric quantity N2 and the body power P1.

In the embodiment, the second power supply 150 supplies the electric energy to the body electronic element, and the first power supply 260 supplies the electric energy to the display screen 270 and the additional electronic element 290. The first service duration is the remaining service duration during which the display screen 270 and the additional electronic element 290 (powered by the first power supply 260) can operate, and the second service duration is the remaining service duration during which the body electronic element (powered by the second power supply 150) can operate. The second service duration may be calculated in many modes, such as directly calculating as N2/P1. In some embodiments, it is also possible to take into account smoking habits of users, different smoking habits may result in different service durations maintained by the same remaining electric quantity. Specifically, the step of calculating the second service duration T2 during which the body electronic element is operable according to the second remaining electric quantity N2 and the body power P1 may include the following steps.

S211: an average smoking duration and an average power consumption of the atomization device for a previous preset number of times are acquired.

In the embodiment, a smoking duration and a power consumption of the atomization device for a single smoking are recorded. The single smoking may refer to taking one puff or multiple puffs. When the single smoking includes multiple puffs, the smoking duration of the single smoking is a total smoking duration of the smoking from a first puff to the last puff. There may exist many modes to record the smoking duration of the single smoking and the power consumption, such as a notebook or the like, and a recorded parameter is stored in a memory device of the atomization device. The preset number of times may be factory-set, or set by the user himself. The preset number of times may be three times, five times, seven times, or the like. The previous preset number of times refers to a preset number of times before the current smoking, which is counted forward from the previous smoking. That the preset number of times is three times is taken as an example, the user smokes at 2:00 PM, 3:00 PM, 4:00 PM, 5:00 PM, and 6:00 PM, respectively, the user smokes five times in total. When the user smokes at 7:00 PM, the previous three times are respectively at 4:00 PM, 5:00 PM, and 6:00 PM. The average smoking duration is the sum of the smoking durations of the preset number of times divided by the preset number of times, and the average power consumption is the sum of the power consumptions of the preset number of times divided by the preset number of times.

S212: an average power consumption rate is calculated according to the average power consumption and the average smoking duration.

In the embodiment, a value obtained by dividing the average power consumption by the average smoking duration serves as the average power consumption rate.

S213: the average power consumption rate is compared to a preset power consumption rate.

The preset power consumption rate is a preset value, and of course, in some embodiments, the preset power consumption rate can be adjusted by the user according to actual conditions. The preset power consumption rate may be a large data value, and may be, for example, an average value in a certain area (e.g., northeast, northwest, southeast, southwest, central, etc.), for a certain age group (e.g., 18-24 years, 25-30 years, 30-40 years), or for a certain gender (e.g., male or female).

S214: when the average power consumption rate is determined to be greater than the preset power consumption rate, T2=αN2/P1, and α ranges from 0.5 to 0.85.

The average power consumption rate is compared to the preset power consumption rate, when the average power consumption rate is greater than the preset power consumption rate, it indicates that the smoking habit of the current user may lead to a faster power consumption (the smoking duration for one puff is shorter, and the evaporation device 170 is turned on and off more times). At the moment, the value of the proportional coefficient α ranges from 0.5 to 0.85, that is, the actual available service duration is 0.5 to 0.85 times N2/P1, and the value of α may be 0.8.

S215: the average power consumption rate is determined to be less than or equal to the preset power consumption rate, T2=βN2/P1, and β is greater than 0.85 and less than 1.

When the average power consumption rate is less than or equal to the preset power consumption rate, it indicates that the smoking habit of the current user may lead to a slower power consumption (the smoking duration for one puff is longer, and the evaporation device 170 is turned on and off fewer times). At the moment, the value of the proportional coefficient a ranges from 0.5 to 0.85, that is, the actual available service duration is 0.5 to 0.85 times N2/P1, wherein the value of is greater than a and less than 1, which may be 0.9.

S220: the first service duration T1 is compared to the second service duration T2.

After the first service duration T1 and the second service duration T2 are acquired, the comparison therebetween is performed.

S230: when the second service duration T2 is determined to be greater than or equal to the first service duration T1, the second service duration T2 serves as the remaining service duration.

When the second service duration T2 is greater than or equal to the first service duration T1, it indicates that the second remaining electric quantity is relatively sufficient to support the body electronic element to operate for a long time. In this case, it is considered that the atomization device can operate normally as long as the body electronic element can operate (accordingly the user can smoke through the atomization device), accordingly the service duration during which the body electronic element can operate is defined as the remaining service duration.

S240: the second service duration T2 is determined to be less than the first service duration T1, the value of [N1−(P2+P3)*T2]/(P1+P2+P3) is calculated and denoted as T3, the sum of T2 and T3 serves as the remaining service duration.

When the second service duration T2 is less than the first service duration T1, it indicates that the second remaining electric quantity is insufficient, so that the body electronic element may operate for a shorter time, and the first remaining electric quantity is large enough to charge the second power supply 150. At the moment, it should be considered that the first remaining electric quantity in the first power supply 260 is supplied into the second power supply 150. Thus, the operation of the atomization device is divided into two phases. In the first phase, the second power supply 150 supplies the electric energy to the body electronic element; the first power supply 260 supplies the electric energy to the additional electronic element 290 and the display screen 270, which are independent of each other. In the second phase, the second power supply 150 is exhausted, and the first power supply 260 simultaneously supplies the electric energy to the body electronic element, the additional electronic element 290, and the display screen 270. The duration of the first phase is T2 and the duration of the second phase is T3. In the calculation of the remaining electric quantity available for T3, it is necessary to consider the electric quantity [(P2+P3)*T2] consumed by the first power supply 260 for supplying the electric energy to the additional electronic element 290 and the display screen 270 in the process of the operation of the body electronic element during T2.

Referring to FIG. 7, in some embodiments, when the total remaining electric quantity is not particularly sufficient, in order to guarantee the operation service duration of the body electronic element, after the step of comparing the total remaining electric quantity to the first preset electric quantity N3, the method may further include the following steps.

S600: when the total remaining electric quantity is determined to be less than or equal to the first preset electric quantity N3, the additional electronic element 290 is turned off.

When the total remaining electric quantity is less than or equal to the first preset electric quantity, it indicates that the current total remaining electric quantity is insufficient. At the moment, the additional electronic element 290 may be turned off to stop the operation of the additional electronic element 290, thereby ensuring that as much electric quantity as possible is used for the operation of the body electronic element.

S700: the remaining service duration is calculated according to the first remaining electric quantity N1, the second remaining electric quantity N2, the body power P1, and the display power P3.

In the above-described condition, only the display screen 270 and the body electronic element operate, and the second power supply 150 supplies the electric energy to the body electronic element, and the first power supply 260 supplies the electric energy to the display screen 270. Accordingly, the remaining service duration can be calculated through the first remaining electric quantity N1, the second remaining electric quantity N2, the body power P1, and the display power P3. The remaining service duration may be calculated in many modes, which may be the sum of the first remaining electric quantity N1 and the second remaining electric quantity N2 divided by the sum of the body power P1 and the display power P3. Alternatively, the remaining service duration may also be calculated in the following embodiments to ensure as long as possible that the body electronic element can operate. Specifically, the second power supply 150 supplies the electric energy to the body electronic element, and the first power supply 260 supplies the electric energy to the display screen 270. The step of calculating the remaining service duration according to the first remaining electric quantity N1, the second remaining electric quantity N2, the body power P1, and the display power P3 may include the following steps.

S710: a value of N1/P3 is calculated and recorded as the first service duration T1, the second service duration T2 during which the body electronic element is operable is calculated according to the second remaining electric quantity N2 and the body power P1.

The first service duration is the remaining service duration during which the display screen 270 can operate (which is powered by the first power supply 260), and the second service duration is the remaining service duration during which the body electronic element can operate (which is powered by the second power supply 150). The second service duration may be calculated in many modes, such as directly calculated as N2/P1. In some embodiments, it is also possible to take into account the smoking habits of users, different smoking habits may result in different service durations maintained by the same remaining electric quantity. Reference can be made to the calculation in the step S210, and the details are not repeated herein.

S720: the first service duration T1 is compared to the second service duration T2.

After the first service duration T1 and the second service duration T2 are acquired, the comparison therebetween is performed.

S730: when the second service duration T2 is determined to be greater than or equal to the first service duration T1, the second service duration T2 serves as the remaining service duration.

When the second service duration T2 is greater than or equal to the first service duration T1, it indicates that the second remaining electric quantity is relatively sufficient to support the body electronic element to operate for a long time. In this case, it is considered that the atomization device can operate normally as long as the body electronic element can operate (accordingly the user can smoke through the atomization device), and therefore the service duration during which the body electronic element can operate is defined as the remaining service duration.

S740: when the second service duration T2 is determined to be less than the first service duration T1, a value of (N1−P3*T2)/(P1+P3) is calculated and denoted as T3, and the sum of T2 and T3 serves as the remaining service duration.

When the second service duration T2 is less than the first service duration T1, it indicates that the second remaining electric quantity is insufficient, so that the body electronic element may operate for a shorter duration; and the first remaining electric quantity is large enough to charge the second power supply 150. At the moment, it should be considered that the first remaining electric quantity in the first power supply 260 is supplied to the second power supply 150. Accordingly, the operation of the atomization device is divided into two phases. In the first phase, the second power supply 150 supplies the electric energy to the body electronic element, and the first power supply 260 supplies the electric energy to the display screen 270, both the first power supply 260 and the second power supply 150 are independent of each other. In the second phase, the second power supply 150 is exhausted, and the first power supply 260 supplies the electric energy to both the body electronic element and the display screen 270 simultaneously. The duration of the first phase is equal to T2 and the duration of the second phase is equal to T3. When the remaining electric quantity available for T3 is calculated, it is necessary to consider the electric quantity (P3*T2) consumed by the first power supply 260 for supplying the electric energy to the display screen 270 in the process of the operation of the body electronic element during T2.

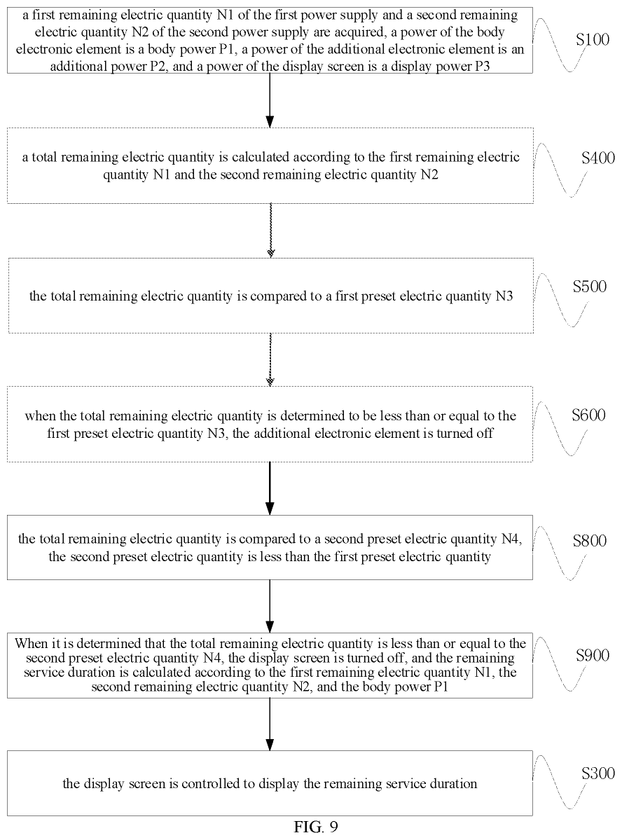

Referring to FIG. 9, in some embodiments, when the total remaining electric quantity is insufficient, in order to ensure the operation duration of the body electronic element, we may select to further turn off the display screen 270, at the moment the total remaining electric quantity can be supplied for the single smoking by the user. Specifically, after the step of comparing the total remaining electric quantity to the first preset electric quantity N3, the method may further include the following steps.

S800: the total remaining electric quantity is compared to a second preset electric quantity N4, the second preset electric quantity is less than the first preset electric quantity.

In the embodiment, the second preset electric quantity N4 is a threshold electric quantity, which may be factory-set, or may be set by a user according to a specific condition. Of course, in some embodiments, the second preset electric quantity N4 may also be set according to a usage habit of the user. For example, the higher the power consumption of the single smoking of the user, the higher the value of the second preset electric quantity N4; the lower the power consumption of the single smoking of the user, the lower the value of the second preset electric quantity N4.

S900: When it is determined that the total remaining electric quantity is less than or equal to the second preset electric quantity N4, the display screen 270 is turned off, and the remaining service duration is calculated according to the first remaining electric quantity N1, the second remaining electric quantity N2, and the body power P1.

When the total remaining electric quantity is less than or equal to the second set electric quantity, it indicates that the current total remaining electric quantity is very low and insufficient to support the normal operation of more electronic elements. At the moment, the display screen 270 is further turned off, leaving only the body electronic element available for operation. The total remaining electric quantity is sufficient for the single smoking of the user.

When it is determined that the total remaining electric quantity is less than or equal to the second preset electric quantity, the first power supply 260 may be utlized to charge the second power supply 150 to transfer the available electric quantity in the first power supply 260 to the second power supply 150. At the moment, the power supply box 200 and the cartomizer 100 can be detached to charge the power supply box 200. Of course, in some embodiments, there are many opportunities to detach the power supply box 200 and the cartomizer 100, which is not particularly limited herein. At the moment, when the remaining service duration is calculated, it is needed to consider the transfer ratio of the electric quantity when charging the second power supply 150 by the first power supply 260.

Specifically, the step of calculating the remaining service lifetime according to the first remaining electric quantity N1, the second remaining electric quantity N2, and the body power P1 may include the following steps.

S910: a transfer ration of the electric quantity charging the second power supply 150 by the first power supply 260 is acquired.

In the embodiment, the transfer ratio η may range from 0.7 to 0.9, which is related to different charging environments and charging conditions.

S920: a value of N1*η is calculated and denoted as a transferred electric quantity N5.

The value of N1*η is the electric quantity transferred from the first remaining electric quantity in the first power supply 260 into the second power supply 150. The sum of N5 and N2 is the remaining electric quantity eventually available for the body electronic element.

S930: a value of (N5+N2)/P1 is calculated as the remaining service duration.

In this operating conidtion, the remaining service duration is equal to the value of the remaining electric quantity divided by the body power. In the embodiment, the situation where the transfer ratio of the electric quantity transferred from the first power supply 260 to the second power supply 150 is considered, so that the finally calculated remaining service duration is more accurate.

The present disclosure further provides an atomization device including a power supply box 200 and a cartomizer 100. The atomization device may further include a processor, a memory storing a program for implementing the method for controlling the atomization device, and the processor is configured to execute the program for implementing the method for controlling the atomization device, to implement the steps of the method for controlling the atomization device.

The method for controlling the atomization device may include:

a first remaining electric quantity N1 of the first power supply 260, and a second remaining electric quantity N2 of the second power supply 150 are acquired, in which a power of the body electronic element is a body power P1, a power of an additional electronic element 290 is an additional power P2, and a power of a display screen 270 is a display power P3;

a remaining service duration is calculated according to the first remaining electric quantity N1, the second remaining electric quantity N2, the body power P1, the additional power P2, and the display power P3;

the display screen 270 is controlled to display the remaining service duration.

Optionally, after the step that the first remaining electric quantity N1 of the first power supply 260, and the second remaining electric quantity N2 of the second power supply 150 are acquired, in which a power of the body electronic element is a body power P1, a power of an additional electronic element 290 is an additional power P2, and a power of a display screen 270 is a display power P3, the method may further include:

a total remaining electric quantity is calculated according to the first remaining electric quantity N1 and the second remaining electric quantity N2;

the total remaining electric quantity is compared to a first preset electric quantity N3;

when the total remaining electric quantity is determined to be greater than the first preset electric quantity N3, the remaining service duration is calculated according to the first remaining electric quantity N1, the second remaining electric quantity N2, the body power P1, the additional power P2, and the display power P3.

Optionally, the second power supply 150 supplies electric energy to the body electronic element, and the first power supply 260 supplies electric energy to the display screen 270 and the additional electronic element 290.

The step of calculating the remaining service duration according to the first remaining electric quantity N1, the second remaining electric quantity N2, the body power P1, the additional power P2, and the display power P3 may further include:

a value of N1/(P2+P3) is calculated and denoted as a first service duration T1, a second service duration T2 during which the body electronic element is operable is calculated according to the second remaining electric quantity N2 and the body power P1;

the first service duration T1 is compared to the second service duration T2;

when the second service duration T2 is determined to be greater than or equal to the first service duration T1, the second service duration T2 serves as the remaining service duration;

when the second service duration T2 is determined to be less than the first service duration T1, a value of [N1−(P2+P3)*T2]/(P1+P2+P3) is calculated and denoted as T3, and a sum of T2 and T3 serves as the remaining service duration.

Optionally, after the step of comparing the total remaining electric quantity to the first preset electric quantity N3, the method may further include:

the additional electronic element 290 is turned off when the total remaining electric quantity is determined to be less than or equal to the first preset electric quantity N3;

the remaining service duration is calculated according to the first remaining electric quantity N1, the second remaining electric quantity N2, the body power P1, and the display power P3.

Optionally, the second power supply 150 supplies electric energy to the body electronic element, and the first power supply 260 supplies electric energy to the display screen 270.

The step of calculating the remaining service duration according to the first remaining electric quantity N1, the second remaining electric quantity N2, the body power P1, and the display power P3 may further include:

a value of N1/P3 is calculated and denoted as a first service duration T1; a second service duration T2 during which the body electronic element is operable is calculated according to the second remaining electric quantity N2 and the body power P1;

the first service duration T1 is compared to the second service duration T2;

when the second service duration T2 is determined to be greater than or equal to the first service duration T1, the second service duration T2 serves as the remaining service duration;

when the second service duration T2 is determined to be less than the first service duration T1, a value of (N1−P3*T2)/(P1+P3) is calculated and denoted as T3, and a sum of T2 and T3 serves as the remaining service duration.

Optionally, after the step of comparing the total remaining electric quantity to the first preset electric quantity N3, the method may further include:

the total remaining electric quantity is compared to a second preset electric quantity N4, in which the second preset electric quantity is less than the first preset electric quantity;

when the total remaining electric quantity is determined to be less than or equal to the second preset electric quantity N4, the display screen 270 is turned off, and the remaining service duration is calculated according to the first remaining electric quantity N1, the second remaining electric quantity N2, and the body power P1.

Optionally, the step of calculating the remaining service duration according to the first remaining electric quantity N1, the second remaining electric quantity N2, and the body power P1 may further include:

a transfer ratio η of an electric quantity charging the second power supply 150 by the first power supply 260 is acquired;

a value of N1*η is calculated and denoted as a transferred electric quantity N5;

a value of (N5+N2)/P1 is calculated and serves as the remaining service duration.

Optionally, the step of calculating the second service duration T2 during which the body electronic element is operable according to the second remaining electric quantity N2 and the body power P1 may further include:

an average smoking duration and an average power consumption of the atomization device for a previous preset number of times are acquired;

an average power consumption rate is calculated according to the average power consumption and the average smoking duration;

the average power consumption rate is compared to a preset power consumption rate;

when the average power consumption rate is determined to be greater than the preset power consumption rate, T2−αN2/P1, and α ranges from 0.5 to 0.85;

when the average power consumption rate is determined to be less than or equal to the preset power consumption rate, T2−βN2/P1, and β is greater than 0.85 and less than 1.

The present disclosure further provides a computer-readable storage medium, on which a control program is stored, the control program when executed by a processor may cause the processor to implement the steps of the method for controlling the atomization device in the above embodiments. The method for controlling the atomization device may include:

a first remaining electric quantity N1 of the first power supply 260, and a second remaining electric quantity N2 of the second power supply 150 are acquired, in which a power of the body electronic element is a body power P1, a power of an additional electronic element 290 is an additional power P2, and a power of a display screen 270 is a display power P3;

a remaining service duration is calculated according to the first remaining electric quantity N1, the second remaining electric quantity N2, the body power P1, the additional power P2, and the display power P3;

the display screen 270 is controlled to display the remaining service duration.

Optionally, after the step that the first remaining electric quantity N1 of the first power supply 260, and the second remaining electric quantity N2 of the second power supply 150 are acquired, in which a power of the body electronic element is a body power P1, a power of an additional electronic element 290 is an additional power P2, and a power of a display screen 270 is a display power P3, the method may further include:

a total remaining electric quantity is calculated according to the first remaining electric quantity N1 and the second remaining electric quantity N2;

the total remaining electric quantity is compared to a first preset electric quantity N3;

when the total remaining electric quantity is determined to be greater than the first preset electric quantity N3, the remaining service duration is calculated according to the first remaining electric quantity N1, the second remaining electric quantity N2, the body power P1, the additional power P2, and the display power P3.

Optionally, the second power supply 150 supplies electric energy to the body electronic element, and the first power supply 260 supplies electric energy to the display screen 270 and the additional electronic element 290.

The step of calculating the remaining service duration according to the first remaining electric quantity N1, the second remaining electric quantity N2, the body power P1, the additional power P2, and the display power P3 may further include:

a value of N1/(P2+P3) is calculated and denoted as a first service duration T1, a second service duration T2 during which the body electronic element is operable is calculated according to the second remaining electric quantity N2 and the body power P1;

the first service duration T1 is compared to the second service duration T2;

when the second service duration T2 is determined to be greater than or equal to the first service duration T1, the second service duration T2 serves as the remaining service duration;

when the second service duration T2 is determined to be less than the first service duration T1, a value of [N1−(P2+P3)*T2]/(P1+P2+P3) is calculated and denoted as T3, and a sum of T2 and T3 serves as the remaining service duration.

Optionally, after the step of comparing the total remaining electric quantity to the first preset electric quantity N3, the method may further include:

the additional electronic element 290 is turned off when the total remaining electric quantity is determined to be less than or equal to the first preset electric quantity N3;

the remaining service duration is calculated according to the first remaining electric quantity N1, the second remaining electric quantity N2, the body power P1, and the display power P3.

Optionally, the second power supply 150 supplies electric energy to the body electronic element, and the first power supply 260 supplies electric energy to the display screen 270.

The step of calculating the remaining service duration according to the first remaining electric quantity N1, the second remaining electric quantity N2, the body power P1, and the display power P3 may further include:

a value of N1/P3 is calculated and denoted as a first service duration T1; a second service duration T2 during which the body electronic element is operable is calculated according to the second remaining electric quantity N2 and the body power P1;

the first service duration T1 is compared to the second service duration T2;

when the second service duration T2 is determined to be greater than or equal to the first service duration T1, the second service duration T2 serves as the remaining service duration;

when the second service duration T2 is determined to be less than the first service duration T1, a value of (N1−P3*T2)/(P1+P3) is calculated and denoted as T3, and a sum of T2 and T3 serves as the remaining service duration.

Optionally, after the step of comparing the total remaining electric quantity to the first preset electric quantity N3, the method may further include:

the total remaining electric quantity is compared to a second preset electric quantity N4, in which the second preset electric quantity is less than the first preset electric quantity;

when the total remaining electric quantity is determined to be less than or equal to the second preset electric quantity N4, the display screen 270 is turned off, and the remaining service duration is calculated according to the first remaining electric quantity N1, the second remaining electric quantity N2, and the body power P1.

Optionally, the step of calculating the remaining service duration according to the first remaining electric quantity N1, the second remaining electric quantity N2, and the body power P1 may further include:

a transfer ratio η of an electric quantity charging the second power supply 150 by the first power supply 260 is acquired;

a value of N1*η is calculated and denoted as a transferred electric quantity N5;

a value of (N5+N2)/P1 is calculated and serves as the remaining service duration.

Optionally, the step of calculating the second service duration T2 during which the body electronic element is operable according to the second remaining electric quantity N2 and the body power P1 may further include:

an average smoking duration and an average power consumption of the atomization device for a previous preset number of times are acquired;

an average power consumption rate is calculated according to the average power consumption and the average smoking duration;

the average power consumption rate is compared to a preset power consumption rate;

when the average power consumption rate is determined to be greater than the preset power consumption rate, T2=αN2/P1, and a ranges from 0.5 to 0.85;

when the average power consumption rate is determined to be less than or equal to the preset power consumption rate, T2=βN2/P1, and β is greater than 0.85 and less than 1.

The aforementioned embodiments are merely some exemplary embodiments of the present disclosure, and thus do not limit the scope of the present disclosure. The equivalent structural variations made using the description and drawings of the present disclosure under the conception of the present disclosure, or direct/indirect use of the same in other relevant technical fields, all fall within the scope of the present disclosure.

What is claimed is:

1. A method for controlling an atomization device, the atomization device comprising a power supply box, a cartomizer storing a liquid to be atomized, a body electronic element, an additional electronic element, and a display screen, the body electronic element being configured to enable the atomization device to transform the liquid to be atomized into an atomizing gas, the additional electronic element being configured to enable the atomization device to implement an additional function, the body electronic element being provided inside the cartomizer, the additional electronic element and the display screen being mounted on the power supply box or on the cartomizer, the power supply box being detachably connected to the cartomizer, a first power supply being provided in the power supply box, a second power supply being provided in the cartomizer, both the first power supply and the second power supply being electrically connected to the body electronic element, the first power supply being electrically connected to the second power supply, the display screen being electrically connected to the first power supply and/or the second power supply, and the additional electronic element being electrically connected to the first power supply and/or the second power supply;
the method comprising:
acquiring a first remaining electric quantity N1 of the first power supply and a second remaining electric quantity N2 of the second power supply, wherein the body electronic element has a body power P1, the additional electronic element has an additional power P2, and the display screen has a display power P3;
calculating a remaining service duration according to the first remaining electric quantity N1, the second remaining electric quantity N2, the body power P1, the additional power P2, and the display power P3; and
controlling the display screen to display the remaining service duration.

2. The method according to claim 1, further comprising:
after acquiring the first remaining electric quantity N1 of the first power supply and the second remaining electric quantity N2 of the second power supply, wherein the body electronic element has the body power P1, the additional electronic element has the additional power P2, and the display screen has the display power P3,
calculating a total remaining electric quantity according to the first remaining electric quantity N1 and the second remaining electric quantity N2;
comparing the total remaining electric quantity to a first preset electric quantity N3; and
when determining that the total remaining electric quantity is greater than the first preset electric quantity N3, calculating the remaining service duration according to the first remaining electric quantity N1, the second remaining electric quantity N2, the body power P1, the additional power P2, and the display power P3.

3. The method according to claim 2, wherein the second power supply supplies an electric energy to the body electronic element, and the first power supply supplies electric energies to the display screen and the additional electronic element;
wherein the calculating the remaining service duration according to the first remaining electric quantity N1, the second remaining electric quantity N2, the body power P1, the additional power P2, and the display power P3 further comprises:
calculating and denoting a value of N1/(P2+P3) as a first service duration T1, calculating a second service duration T2 during which the body electronic element is operable according to the second remaining electric quantity N2 and the body power P1;
comparing the first service duration T1 to the second service duration T2;
when determining that the second service duration T2 is greater than or equal to the first service duration T1, determining the second service duration T2 as the remaining service duration; and
when determining that the second service duration T2 is less than the first service duration T1, calculating and denoting a value of [N1−(P2+P3)*T2]/(P1+P2+P3) as T3, and determining a sum of T2 and T3 as the remaining service duration.

4. The method according to claim 2, further comprising:
after comparing the total remaining electric quantity to the first preset electric quantity N3,
turning off the additional electronic element when determining that the total remaining electric quantity is less than or equal to the first preset electric quantity N3; and
calculating the remaining service duration according to the first remaining electric quantity N1, the second remaining electric quantity N2, the body power P1, and the display power P3.

5. The method according to claim 4, wherein the second power supply supplies an electric energy to the body electronic element, and the first power supply supplies an electric energy to the display screen;
wherein the calculating the remaining service duration according to the first remaining electric quantity N1, the second remaining electric quantity N2, the body power P1, and the display power P3 further comprises:
calculating and denoting a value of N1/P3 as a first service duration T1, calculating a second service duration T2 during which the body electronic element is operable according to the second remaining electric quantity N2 and the body power P1;
comparing the first service duration T1 to the second service duration T2;
when determining that the second service duration T2 is greater than or equal to the first service duration T1, determining the second service duration T2 as the remaining service duration; and
when determining that the second service duration T2 is less than the first service duration T1, calculating and denoting a value of (N1-P3*T2)/(P1+P3) as T3, and determining a sum of T2 and T3 as the remaining service duration.

6. The method according to claim 2, further comprising:
after comparing the total remaining electric quantity to the first preset electric quantity N3,
comparing the total remaining electric quantity to a second preset electric quantity N4, wherein the second preset electric quantity is less than the first preset electric quantity; and
when determining that the total remaining electric quantity is less than or equal to the second preset electric quantity N4, turning off the display screen, and calculating the remaining service duration according to the first remaining electric quantity N1, the second remaining electric quantity N2, and the body power P1.

7. The method according to claim 6, wherein the calculating the remaining service duration according to the first remaining electric quantity N1, the second remaining electric quantity N2, and the body power P1 further comprises:
acquiring a transfer ratio η of an electric quantity charging the second power supply by the first power supply;
calculating and denoting a value of N1*η as a transferred electric quantity N5; and
calculating and determing a value of (N5+N2)/P1 as the remaining service duration.

8. The method according to claim 3, wherein the calculating the second service duration T2 during which the body electronic element is operableaccording to the second remaining electric quantity N2 and the body power P1 further comprises:
acquiring an average smoking duration and an average power consumption of the atomization deivice for a previous preset number of times;
calculating an average power consumption rate according to the average power consumption and the average smoking duration;
comparing the average power consumption rate to a preset power consumption rate;
when determining that the average power consumption rate is greater than the preset power consumption rate, the second service duration T2 is determined by T2=αN2/P1, wherein α ranges from 0.5 to 0.85; and
when determining that the average power consumption rate is less than or equal to the preset power consumption rate, the second service duration T2 is determined by T2=βN2/P1, wherein β is greater than 0.85 and less than 1.

9. The method according to claim 5, wherein the calculating the second service duration T2 during which the body electronic element is operableaccording to the second remaining electric quantity N2 and the body power P1 further comprises:
acquiring an average smoking duration and an average power consumption of the atomization deivice for a previous preset number of times;
calculating an average power consumption rate according to the average power consumption and the average smoking duration;
comparing the average power consumption rate to a preset power consumption rate;
when determining that the average power consumption rate is greater than the preset power consumption rate, the second service duration T2 is determined by T2=αN2/P1, wherein α ranges from 0.5 to 0.85; and
when determining that the average power consumption rate is less than or equal to the preset power consumption rate, the second service duration T2 is determined by T2=βN2/P1, wherein β is greater than 0.85 and less than 1.

10. An atomization device, comprising a power supply box and a cartomizer,
further comprising a processor and a memory storing a control program, wherein the processor, when executing the comotrol program, implements the steps of the method for controlling the atomization device of claim 1.

11. A computer-readable storage medium, on which a control program is stored, wherein the control program, when executed by a processor, causes the processor to implement the steps of the method for controlling the atomization device of claim 1.
